(19) United States
(12) Patent Application Publication
(10) Pub. No.: US 2017/0140678 A1
(43) Pub. Date: May 18, 2017

(54) METER TICKET HOLDER

(71) Applicants: Jerry Lewis Shepard, Queens Village, NY (US); Eartha Mae Shepard, Jamaica, NY (US); Charles Washington, Bronx, NY (US)

(72) Inventors: Jerry Lewis Shepard, Queens Village, NY (US); Eartha Mae Shepard, Jamaica, NY (US); Charles Washington, Bronx, NY (US)

(21) Appl. No.: 14/939,104

(22) Filed: Nov. 12, 2015

(51) Int. Cl. G09F 3/20; B60R 7/06; B60R 7/08; B60R 11/00

(52) U.S. Cl. CPC G09F 3/20; B60R 11/00; B60R 7/06; B60R 7/08; B60R 2011/0005

(57) ABSTRACT

A meter ticket holder is provided. The meter ticket holder includes a stand and a plate support. The stand includes a base portion joined with an uptight portion. The upright portion is disposed at an acute angle relative to the base portion. The upright portion includes a first mating connector. The base portion is configured to support the stand in an upright position when resting on a surface. The plate support includes a front surface and a rear surface. The rear surface includes a second mating connector releasably attached to the first mating connector. A ledge is protruding from a bottom edge of the front surface of the plate support and supports the meter ticket when placed onto the plate support.

### BACKGROUND OF THE INVENTION

The present invention relates to a meter ticket holder for any vehicle.

Meter tickets are typically used to keep track of payments due, or already paid for use of a parking garage or road-side curve space. Currently, when paying a meter ticket, the meter ticket must be visible on the dashboard of the vehicle. When the ticket is merely placed on the dashboard, the ticket may not be visible to the ticket examiner.

There are other devices that may be used to affix the meter ticket to a user's windshield. However, these devices are not easy to be removed from the windshield, and leave a gluey mess on the vehicle windshield when removed.

As can be seen, there is a need for an improved meter ticket holder for prominently displaying a meter ticket through a windshield.

### SUMMARY OF THE INVENTION

In one aspect of the present invention, a meter ticket holder comprises: a stand comprising a base portion joined with an upright portion, wherein the upright portion is disposed at an angle relative to the base portion and comprises a first mating connector, wherein the base portion is configured to support the stand in an upright position when resting on a surface; and a plate support comprising a front surface and a rear surface, wherein the rear surface comprises a second mating connector releasably attached to the first mating connector, wherein a ledge is protruding from a bottom edge of the front surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a front perspective view of an embodiment of the present invention;

FIG. 3 is a rear perspective view of an embodiment of the present invention;

FIG. 4 is an exploded view of an embodiment of the present invention;

FIG. 5 is a section view of the present invention taken along line 5-5 in FIG. 2; and

FIG. 6 is a section view of the present invention taken along line 6-6 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a dashboard stand for vehicles. The stand holds and displays a meter ticket so it may be shown prominently through the front windshield. Further, the stand may be taken apart and stored when not in use. The present invention allows for a meter ticket examiner to check each and every meter ticket with relative ease, since using the present invention prominently displays the meter ticket through the front windshield.

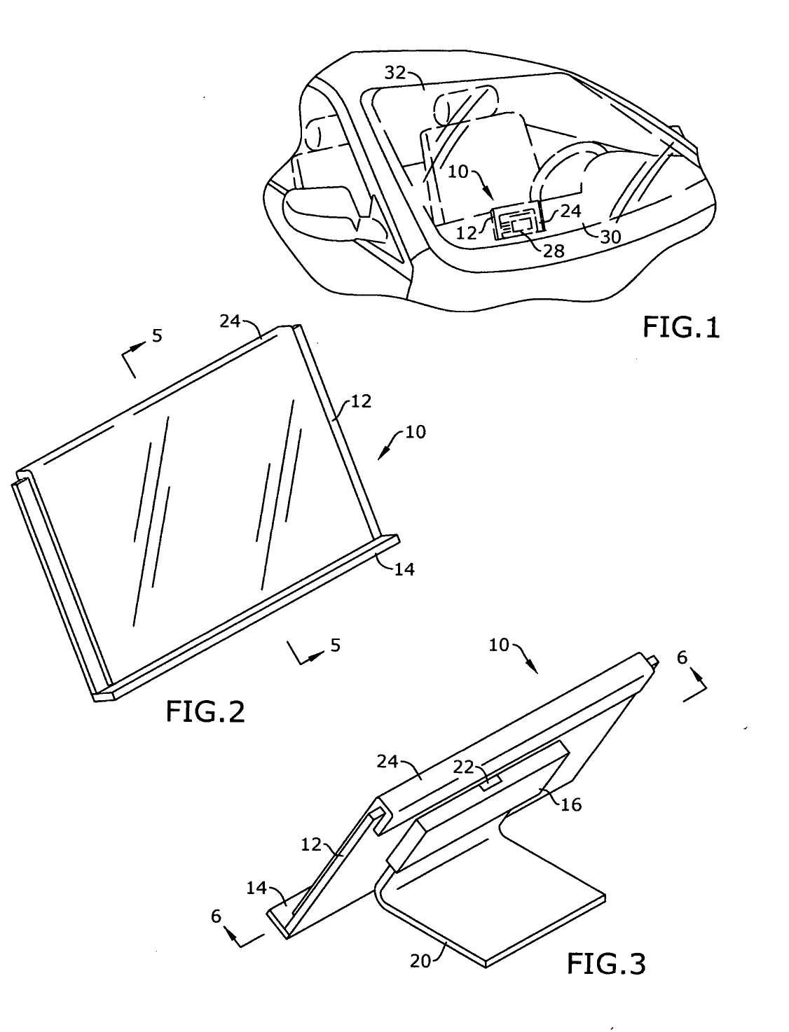

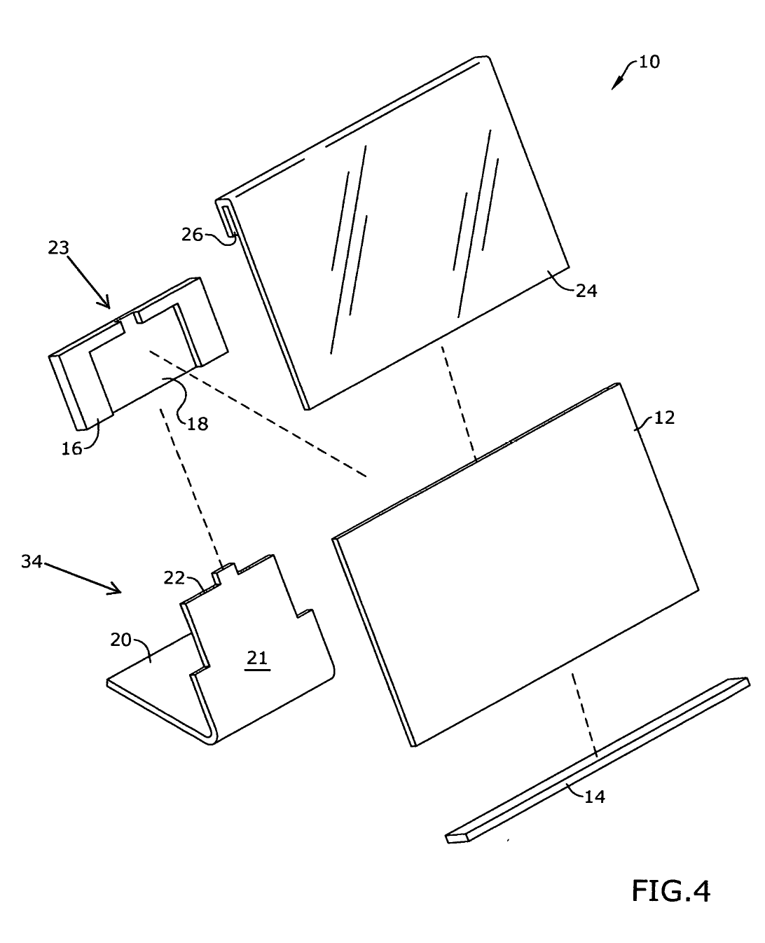

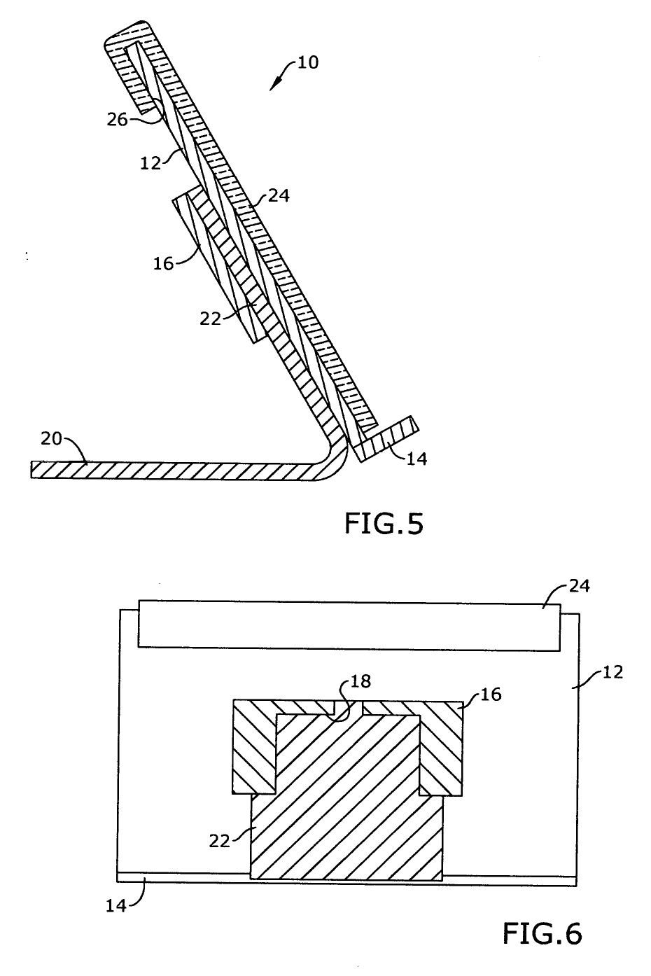

Referring to FIGS. 1 through 6, the present invention includes a meter ticket holder 10. The meter ticket holder 10 includes a stand 34 and a plate support 12. The stand 34 includes a base portion 20 joined with an upright portion 21. The upright portion 22 is disposed at an acute angle relative to the base portion 20. The upright portion 21 includes a first mating connector 22. The base portion 20 is configured to support the stand in an upright position when resting on a surface. The plate support 12 includes a front surface and a rear surface. The rear surface includes a second mating connector 23 releasably attached to the first mating connector 22. A ledge 14 is protruding from a bottom edge of the front surface of the plate support 12 and supports the meter ticket 28 when placed onto the plate support 12.

In certain embodiments, the present invention includes a stand support 16. The stand support 16 is fixed to the rear surface of the plate support 12. The stand support 16 forms a slot 18, thereby forming the second mating connector 23. A top portion of the upright portion 21 forms a stand insert forming the first mating connector 22. The stand insert is sized to fit within the slot 18 of the stand support 16, thereby releasably connecting the stand 34 and the plate support 12 together. The plate support 12 may easily be separated from the stand 34 by removing the stand insert from the slot 18. Once separate, the meter ticket holder 10 may be placed in a discreet location.

In certain embodiments, the first mating portion 22 may form a lower notch and an upper notch. The lower notch may be substantially wider than the upper notch. The second mating portion 23, including the slot 18, may form a lower slot and an upper slot. The lower slot may be substantially wider than the upper slot. The upper notch may slide into the upper slot, and the lower notch may slide into the lower slot, thereby releasably connecting the first and second mating portions 22, 23.

The plate support 12 of the present invention may include a substantially flat plate having a planar front surface and a planar rear surface. The plate support 12 includes an upper edge, a lower edge opposite the upper edge, a first side edge and a second side edge opposite the first side edge. As mentioned above, a ledge 14 may extend from the lower edge of the front surface of the plate support 12. In certain embodiments, the ledge 14 may extend along the entire bottom edge, allowing varied placements of the meter ticket 28. The plate support 12 is attached to the stand 34 at an angle, such as a 45 degree angle. Therefore, the meter ticket 28 may rest against the ledge 14 due to gravity.

In certain embodiments, the present invention may include a transparent plate 24. The transparent plate 24 is releasably attached to the plate support 12 and disposed to cover the front surface, thereby sandwiching the meter ticket 28 in between the transparent plate 24 and the plate support 12. In certain embodiments, the transparent plate 24 may include an upper channel 26 sized to receive the upper edge of the plate support 12, thereby releasably retaining to the plate support 12. The upper channel 26 may be formed by the upper edge of the transparent plate 24 forming a U-bend towards an inner surface of the transparent plate 24. The U-bend is sized to fit over the edge of the plate support 12. The transparent plate 24 is used to secure the meter ticket 28 in place on the plate support 12.

The present invention further includes a method of securing a meter ticket 28 to a dashboard 30 of a vehicle. The base portion 20 of the stand 34 is placed on the dashboard 30 of the vehicle. The first mating connector 22 of the stand is connected with a second mating connector 23 of the plate support 12. In certain embodiments, the stand insert of the stand 34 is inserted into the slot 18 formed through the stand support 16. The meter ticket 28 is then placed onto the front surface of the plate support 12 and rests against the ledge 14. The transparent plate 24 is then attached to the plate support 12 and covers the meter ticket 28 and the front surface of the plate support 12. The transparent plate 24 may be attached to the plate support 12 by inserting a top edge of the plate support 12 within an upper channel 26 formed on the transparent plate 24. The meter ticket 28 may be seen through the windshield 32 of the vehicle.

A method of making the present invention may include the following. The present invention is not limited to the sizes listed below or the method of making described. The below disclosure is for exemplary purposes. Cut a black piece of acrylic plastic in the dimensions of 3½″×6″, and at about ¼″ thickness. The plastic forms the plate support inclined holder. Next, cut another black piece of acrylic plastic in the dimensions of ½″×6″. The plastic piece may be the bottom ledge. Attach the ledge to the bottom edge of the plate support. This may be performed by gluing the widest side of the Bottom Ledge to the front, bottom edge of the plate support. A plastic acrylic solvent glue may be used for bonding the plastic pieces together. Next, use a hand pressure vice for about ten minutes to ensure bonding of these two pieces of plastic. Cut another piece of black acrylic plastic in the dimensions of 1¼″×3″. On one side of this plastic, cut out a 2″×1″ piece, and ⅛″ deep. After this cut, on one side, at the top, a lip may remain. Cut into the center of the lip, creating a channel in the lip. The dimensions of the channel may be about ⅛″×¾″. Then take a piece of clear plastic to cut the stand. The starting dimensions of this plastic may be about 2½″×4¾″. After cutting this plastic to a form, the dimension should be about ⅜″× 6/8″×1″×1 6/8″×3 4/8″×2½″. Measure the back side horizontally to the center of the support plate, which is 3″. Take the second mating connector, which may be about 1¼″×3″, and glue it to the back side of the plate support in the center at about 1″ from the bottom edge. Next, bend the stand, at about 1″ from the top of this clear piece of plastic. This will be the prop or stand that holds up the plastic front plate inclined holder for viewing. Take the removable front face clear guard, about 4½″×5½″, and measure out about 3 7/16″ from the bottom of this piece of clear plastic, and mark this by drawing a line across the plastic. Again, from the bottom of this piece of clear plastic, measure about 3 13/16″, and mark this measurement by drawing a line across the plastic creating two horizontal lines, one at about 3 7/16″ from the bottom of the plastic, and the other line at about 3 13/16″, also measuring from the bottom of the plastic. Between these two horizontal lines, there is a space separating them with a measurement of about 6/16″. At these two measured horizontal lines, bend the plastic. This bending of the plastic creates the removable front face clear guard, about 4½″×5½″. This guard rests on the top edge of the plastic front plate inclined holder, which guards and holds the meter ticket in place for viewing.

It should be understood, of course, that the foregoing relates to exemplary embodiments of the invention and that modifications may be made without departing from the spirit and scope of the invention as set forth in the following claims.

What is claimed is:

1. A meter ticket holder comprising:
a stand comprising a base portion joined with an upright portion, wherein the upright portion is disposed at an angle relative to the base portion and comprises a first mating connector, wherein the base portion is configured to support the stand in an upright position when resting on a surface; and
a plate support comprising a front surface and a rear surface, wherein the rear surface comprises a second mating connector releasably attached to the first mating connector, wherein a ledge is protruding from a bottom edge of the front surface.

2. The meter ticket holder of claim 1, further comprising a stand support comprising a slot, wherein the stand support is secured to the rear surface of the plate support forming the second mating connector.

3. The meter ticket holder of claim 2, wherein a top portion of the upright portion forms a stand insert forming the first mating connector, wherein the stand insert is sized to fit within the slot of the stand support, thereby releasably connecting the stand and the plate support.

4. The meter ticket holder of claim 1, further comprising a transparent plate releasably attached to the plate support and disposed to cover the front surface.

5. The meter ticket holder of claim 4, wherein the transparent plate further comprises an upper channel sized to receive an upper edge of the plate support.

6. A method of securing a meter ticket to a dashboard of a vehicle comprising:
placing a base portion of a stand on the dashboard of the vehicle, wherein the stand comprises an upright portion extending from and disposed at an angle relative to the base portion, wherein the upright portion comprises a first mating connector;
connecting a second mating connector to the first mating connector, wherein the second mating connector is secured to a rear surface of a plate support; and
resting a meter ticket on a ledge protruding from a bottom edge of a front surface of the plate support.

7. The method of claim 6, further comprising attaching a transparent plate to the front surface of the plate support, thereby covering the meter ticket.

8. The method of claim 7, wherein the step of attaching the transparent plate to the front surface of the plate support comprises inserting a top edge of the plate support within an upper channel formed on the transparent plate.
